(19) United States
(12) Patent Application Publication
(10) Pub. No.: US 2025/0123459 A1
(43) Pub. Date: Apr. 17, 2025

(54) SPACED SZ STRANDING WITHIN FIBER CABLE

(71) Applicant: CommScope Technologies LLC, Claremont, NC (US)

(72) Inventors: Daniel J. Parke, Hickory, NC (US); Frank K. Wyatt, Mooresville, NC (US)

(21) Appl. No.: 18/822,016

(22) Filed: Aug. 30, 2024

Related U.S. Application Data
(60) Provisional application No. 63/543,693, filed on Oct. 11, 2023.

(51) Int. Cl. G02B 6/44

(52) U.S. Cl. CPC G02B 6/4434; G02B 6/4431; G02B 6/4432; G02B 6/449

(57) ABSTRACT

An optical cable includes a central strength member. A buffer tube, surrounding at least one optical fiber, is SZ stranded around the strength member. An air gap exists between adjacent lays of the buffer tube as the buffer tube follows a SZ stranding path along the strength member. The buffer tube has a diameter and occupies a first angular portion of the three hundred sixty degrees surrounding the strength member, and the air gap occupies a second angular portion of the three hundred sixty degrees surrounding the strength member, which is greater than the first angular portion. At least one element holds the buffer tube in the SZ stranding path along the strength member, and an outer jacket surrounds the at least one element, the buffer tube and the strength member.

This application claims the benefit of U.S. Provisional Application No. 63/543,693, filed Oct. 11, 2023, which is herein incorporated by reference.

### BACKGROUND OF THE INVENTION

### 1. Field of the Invention

The present invention relates to a fiber optic communications cable with one or more buffer tubes and a central strength member, such as a fiber reinforced plastic (FRP) member. More particularly, the present invention has one or more buffer tubes SZ stranded around the central strength member and the SZ stranding pattern presents a continuous space gap along the central strength member, which space gap exceeds the diameter of a buffer tube.

### 2. Description of the Background

FIG. 1A depicts a cable 20 in accordance with the prior art. The cable 20 includes up to six buffer tubes 21, each of which contains a plurality of optical fibers 22, e.g., four, six eight, twelve. In FIG. 1A, six optical fibers 22 are shown in each buffer tube 21. One or more of the buffer tubes 21 may be replaced by a filler rod 28, e.g., one, two, three, four or five of the buffer tubes 21 may be replaced by a filler rod 28, if a cable 20 with a lower fiber count is needed. The filler rod 28 may be constructed as a solid rod formed of a dielectric material having a same diameter as a buffer tube 21. FIG. 1A shows four filler rods 28 placed symmetrically within the cable 20.

The buffer tubes 21 and filler rods 28 are stranded about a central strength member 23, e.g., a glass reinforced plastic (GRP) rod, wherein fibers to enhance strength are distributed throughout a semi-rigid dielectric rod. The central strength member 23 provides mechanical strength to a length of the cable 20, e.g., in a drop cable deployment, and also provides a good anchoring point for a connector at a cable termination.

Typically, the buffer tubes 21 and filler rods 28 are stranded about the central strength member 23 in a S-Z stranding pattern. As best seen in FIG. 1B, in the S-Z stranding pattern the buffer tubes 21 and filler rods 28 twist about the central strength member 23 for several revolutions in a clockwise direction, e.g., five to seven revolutions, then reverse direction at a first switchback 27 and twist about the central strength member 23 for several revolutions in a counter-clockwise direction, e.g., five to seven revolutions, to a second switchback 29. A pattern of clockwise rotations in zones A and counterclockwise rotations in zones B repeats along the length of the cable 20 between first, second, third, fourth, etc. switchbacks 27, 29, 31, 33, etc.

The central strength member 23 is “centrally” positioned within a cable jacket 24 and is not stranded, i.e., the central strength member 23 does not relocate its position within the jacket 24 either helically or in the S-Z stranding pattern, as do the other members of the cable core. Further, the central strength member 23 is not twisted about its central axis. In other words, nothing in the cable manufacturing process imparts a twist to the central strength member 23 about its central axis and no feature of the central strength member 23 exhibits a twisted appearance, as such a twist would produce no known benefit since the central strength member is a cylindrical rod.

During manufacturing, the central strength member 23 is paid off a reel and fed into a position, which will become the center of a cable core and hence the center of the overall cable. The buffer tubes 21 and filler rods 28 are SZ stranded about the central strength member 23, and one or two binders 35 and 37 are wrapped about the buffer tubes 21, and any filler rods 28, to keep the cable core intact as the cable core is further processed during manufacturing.

Next, an additional layer 25, such as an armor layer, a shielding layer, a water blocking tape, and/or a layer of aramid, polyester, or flexible fiberglass yarns is applied around the cable core. The additional layer 25 surrounds the cable core. Finally, the cable jacket 24 is extruded around the additional layer 25 to form the optical cable 20. Ripcords 26 may optionally be positioned within the cable 20 to facilitate opening of the cable jacket 24 and additional layer 25 to permit access to the cable core.

Other configurations of optical cables with buffer tubes surrounding a central strength member are generally known in the prior art. For example, see U.S. Pat. Nos. 8,165,439; 8,380,029; 10,191,237; 10,310,192; 10,649,163 and 11,095,103, and US Published Application 2004/0120664, each of which is herein incorporated by reference.

### SUMMARY OF THE INVENTION

The applicant has appreciated drawbacks with the designs of the optical cables of the prior art.

The typical design of an optical cable 20, shown in the prior art discussed above, has a central strength member 23 and buffer tubes 21 stranded about the central strength member 23. This typical design results in an optical cable 20 wherein an outer surface of the cable jacket 24 has a desirable circular cross-section. The ratio of buffer tubes 21/filler rods 28 around the central strength member 23 is usually five-around-one, six-around-one or seven-around-one. The outermost radial surfaces of the buffer tubes 21 and filler rods 28 (distanced furthest away from the central strength member 23) provide supporting “contact surfaces” for the additional layer 25 which supports the cable jacket 24. The evenly spaced, multiple “contact surfaces” result in the circular outer surface of the cable jacket 24.

As shown in FIG. 1A, it has been considered important in the prior art to include a continuum of abutting buffer tubes 21 and filler rods 28 around the perimeter of the central strength member 23 so that the outer surface of the cable jacket 24 will be circular in cross-section. To accommodate five-around-one and seven-around-one configurations, the prior art would vary the outer diameter of the central strength member 23, to be smaller in the case of the five-around-one configuration and larger in the case of the seven-around-one configuration, so that the buffer tubes 21 and filler rods 28 would stay in a continuum of abutments as they were stranded around the central strength member 23.

It is an object of the present invention to provide an optical cable which reduces the overall diameter of the optical cable and reduces the number of components in the cable core while maintaining the same number of optical fibers. It is an object of the present invention to provide a cable which is easier to install, e.g., has a lighter weight and has an improved bend radius. It is an object of the present invention to provide a cable which is cheaper to manufacture.

It is an object of the present invention to provide an optical cable which is an improvement from an environmental (green) perspective in that the cable uses less materials to perform the same functions, and has a smaller footprint, which may be beneficial from a densification perspective especially when the cable is used in a conduit or a similar pathway, and may be beneficial from a wind and ice load perspective when the cable is used in an environmentally exposed situation.

It is an object of the present invention to provide an optical cable with one or two buffer tubes stranded about a central strength member, but rejects the teachings of the prior art to have a continuum of abutted buffer tubes and filler rods within the stranding for the purpose of forming a circular outer jacket. The present invention contains a space gap in the stranded core of cable elements about the central strength member.

In preferred embodiments, it is an object of the present invention to provide an optical cable wherein no filler rods or at least less filler rods are stranded about the central strength member leaving an air gap in the stranding pattern. The resulting cable presents a non-circular outer surface on the outer jacket of the cable, as viewed in cross-section.

These and other objectives are accomplished by an optical cable including a central strength member. A buffer tube, surrounding at least one optical fiber, is SZ stranded around the strength member. An air gap exists between adjacent lays of the buffer tube as the buffer tube follows a SZ stranding path along the strength member. The buffer tube has a diameter and occupies a first angular portion of the three hundred sixty degrees surrounding the strength member, and the air gap occupies a second angular portion of the three hundred sixty degrees surrounding the strength member, which is greater than the first angular portion. At least one element holds the buffer tube in the SZ stranding path along the strength member, and an outer jacket surrounds the at least one element, the buffer tube and the strength member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For a better understanding of the invention, and to show how the same may be carried into effect, reference will now be made, by way of example, to the accompanying drawings, in which:

FIG. 1A is an end view of a cable with buffer tubes and filler rods stranded around a central strength member to form a cable core, in accordance with the prior art;

FIG. 1B is a side view of the cable of FIG. 1A with a portion of an outer jacket and armor layer removed to illustrate a stranding of the cable core held by binders;

FIG. 2 is a side view of a three-member cable core in accordance with the present invention, with the binders, armor layer and outer jacket removed;

FIG. 3 is a cross-sectional view taken along lines A-A in FIG. 2 of an optical cable in accordance with a first embodiment of the present invention;

FIG. 4 is a cross-sectional view taken along line B-B in FIG. 2 of the optical cable in accordance with the first embodiment of the present invention;

FIG. 5 is a cross-sectional view taken along line C-C in FIG. 2 of the optical cable in accordance with the first embodiment of the present invention;

FIG. 6 is a cross-sectional view taken along line D-D in FIG. 2 of the optical cable in accordance with the first embodiment of the present invention;

FIG. 7 is a cross-sectional view taken along lines A-A in FIG. 2 of an optical cable in accordance with a second embodiment of the present invention;

FIG. 8 is a cross-sectional view taken along line B-B in FIG. 2 of the optical cable in accordance with the second embodiment of the present invention;

FIG. 9 is a cross-sectional view taken along line C-C in FIG. 2 of the optical cable in accordance with the second embodiment of the present invention;

FIG. 10 is a cross-sectional view taken along line D-D in FIG. 2 of the optical cable in accordance with the second embodiment of the present invention;

FIG. 11 is a side view of a four-member cable core in accordance with the present invention, with the binders, armor layer and outer jacket removed;

FIG. 12 is a cross-sectional view taken along lines E-E in FIG. 11 of an optical cable in accordance with a third embodiment of the present invention;

FIG. 13 is a cross-sectional view taken along line F-F in FIG. 11 of the optical cable in accordance with the third embodiment of the present invention;

FIG. 14 is a cross-sectional view taken along line G-G in FIG. 11 of the optical cable in accordance with the third embodiment of the present invention;

FIG. 15 is a cross-sectional view taken along line H-H in FIG. 11 of the optical cable in accordance with the third embodiment of the present invention;

FIG. 16 is a cross-sectional view taken along lines E-E in FIG. 11 of an optical cable in accordance with a fourth embodiment of the present invention;

FIG. 17 is a cross-sectional view taken along line F-F in FIG. 11 of the optical cable in accordance with the fourth embodiment of the present invention;

FIG. 18 is a cross-sectional view taken along line G-G in FIG. 11 of the optical cable in accordance with the fourth embodiment of the present invention; and

FIG. 19 is a cross-sectional view taken along line H-H in FIG. 11 of the optical cable in accordance with the fourth embodiment of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

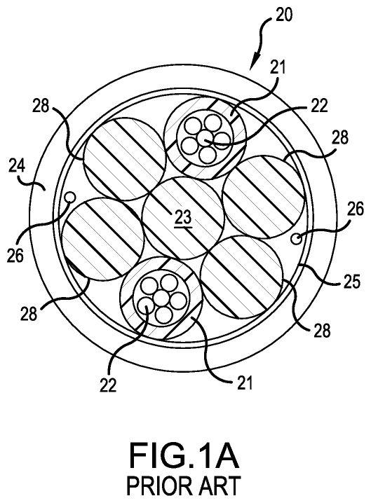

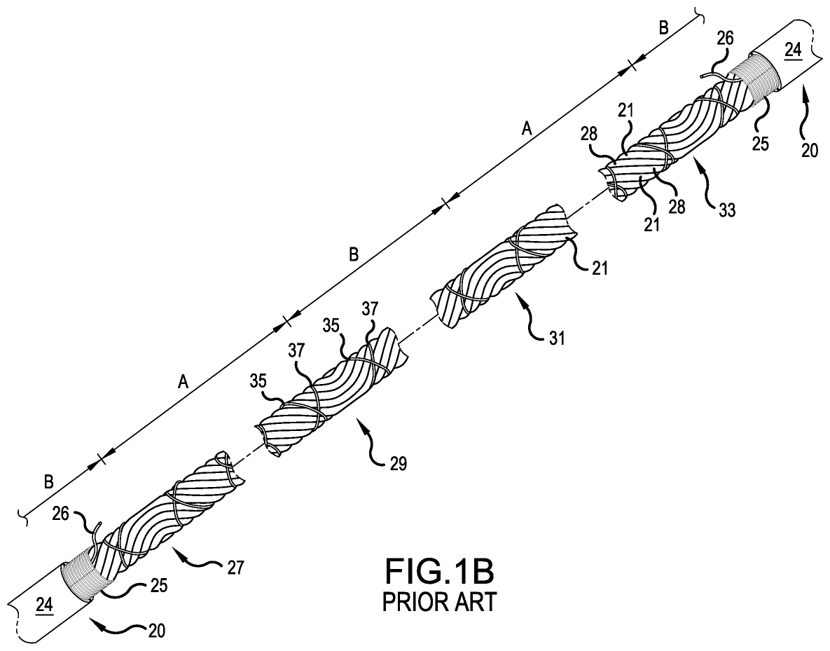

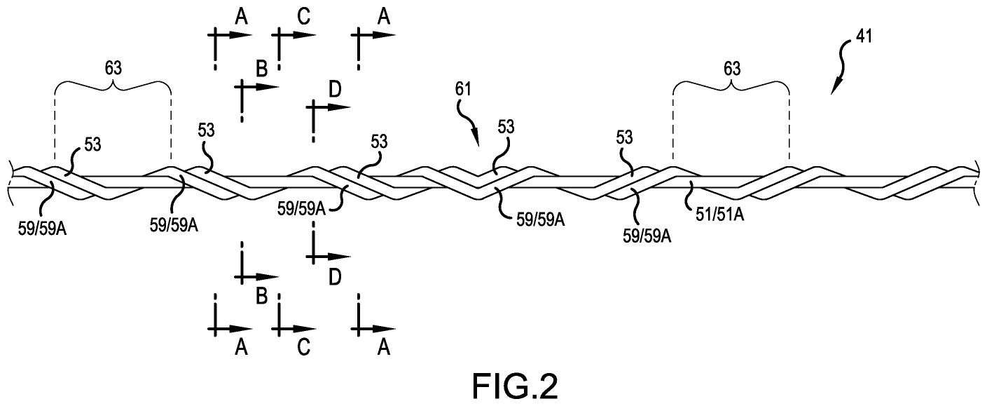

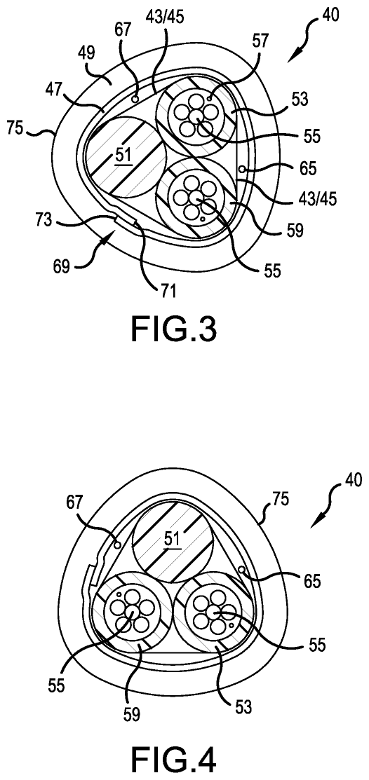

FIG. 2 is a side view of a three-member cable core 41 in accordance with the present invention. The cable core 41 would be surrounded by one or two binders 43 and 45 and an optional additional layer 47 (described with reference to elements 25, 35 and 37 in the background section), such as an armor layer 47, which supports an outer cable jacket 49. The one or two binders 43 and 45, armor layer 47, and outer jacket 49 are removed in FIG. 2 to simplify the drawing but would be applied to the cable core 41 in a similar manner as the one or two binders 35 and 37, the armor layer 25, and the outer jacket 24 are applied to the cable core in FIGS. 1A and 1B. FIG. 3 is a cross-sectional view taken along line A-A in FIG. 2 of an optical cable 40 in accordance with a first embodiment of the present invention. In FIG. 3, the one or two binders 43 and 45, the armor layer 47, and the outer jacket 49 are included in the drawing.

In FIGS. 2 and 3, the cable core 41 of the optical cable 40 includes a central strength member 51. A first buffer tube 53 is stranded around the central strength member 51 along a length of the optical cable 40. The first buffer tube 53 has an outer diameter of about 2.5 mm, e.g., about 0.1 inches, although other sized buffer tubes may be used, such as a 2.0 mm buffer tube. The first buffer tube 53 surrounds six optical fibers 55 and one or more ripcords 57. However, other numbers of optical fibers 55 and ripcords 57 may be surrounded by the first buffer tube 53, such as at least eight or at least twelve optical fibers 55. For example in a preferred embodiment, when the first buffer tube 53 is sized at 2.5 mm and the optical fibers 55 have a 200 micron diameter, the first buffer tube 53 may surround twenty-four optical fibers 55 and one or more ripcords 57. A second buffer tube 59 is also stranded around the central strength member 51 along a length of the optical cable 40. The second buffer tube 59 may be formed the same as the first buffer tube 53, and surround a plurality of optical fibers 55, such as six optical fibers 55 as shown, or up to twenty-four optical fibers 55, as discussed above.

The first and second buffer tubes 53 and 59 are stranded about the central strength member 51 in a S-Z stranding pattern. As best seen in FIG. 2, in the S-Z stranding pattern, the first and second buffer tubes 53 and 59 twist about the central strength member 51 for several revolutions in a clockwise direction, e.g., five to seven revolutions, then reverse direction at first switchback 61 and twist about the central strength member 51 for several revolutions in a counter-clockwise direction, e.g., five to seven revolutions, to another switchback. A pattern of clockwise rotations and counterclockwise rotations repeats along the length of the cable core 41 of the optical cable 40, in a manner similar to the zones A and B between first, second, third, fourth, etc. switchbacks 27, 29, 31, 33, shown in FIG. 1B.

In FIG. 2, an air gap 63 exists between the first buffer tube 53 and the second buffer tube 59, as the first and second buffer tubes 53 and 59 follow a SZ stranding path along the central strength member 51. In FIG. 2, the SZ stranding pattern is the same as a five-around-one pattern, with the first and second buffer tubes 53 and 59 occupying the positions of the first and second cable elements being SZ stranded around the central strength member 51. No cable elements exist in the third, fourth and fifth positions of the five-around-one configuration. Rather, the third, fourth and fifth positions constitute the air gap 63. In other words, if a diameter of the first buffer tube 53 is equal to a diameter of the second buffer tube 59, and if three filler rods, having a same diameter as the first and second buffer tubes 53 and 59 were stranded along with the first and second buffer tubes 53 and 59, the stranding would be a five-around-one configuration with no air gaps. A cross-section of such an arrangement would show a continuum of abutments between the first and second buffer tubes 53 and 59 and the three filler rods, similar to the abutments shown in the six-around-one configuration of FIG. 1A.

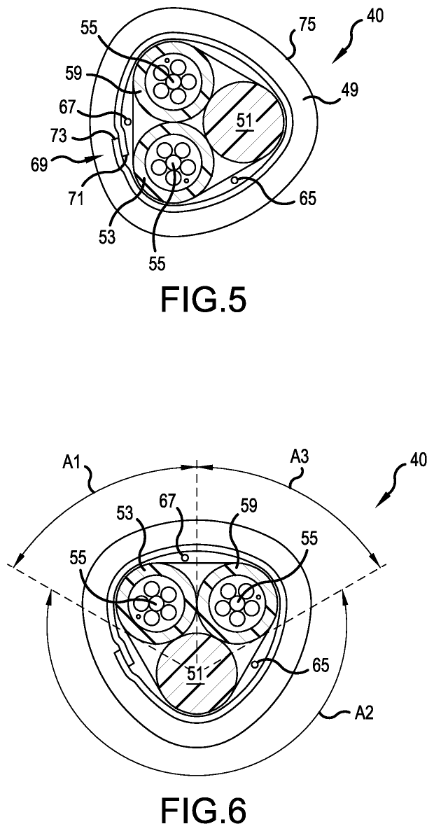

As best seen in FIG. 6, the first buffer tube 53 has a first diameter and occupies a first angular portion A1 of the three hundred sixty degrees surrounding the central strength member 51. Also, the air gap 63 occupies a second angular portion A2 of the three hundred sixty degrees surrounding the central strength member 51. In a preferred embodiment the angle of the second angular portion A2 is greater than the angle of the first angular portion A1, such as the second angular portion A2 is at least twice as large as the first angular portion A1. Also, the angle of the remaining third angular portion A3 equals the angle of the first angular portion A1, when a diameter of the second buffer tube 59 is equal to a diameter of the first buffer tube 53.

In a preferred embodiment, the central strength member 51 has a diameter of about 2.5 mm, e.g., about 0.1 inches, although the diameter may be different, e.g., smaller or larger. The central strength member 51 may be formed as a fiber reinforced plastic (FRP) rod or other strong material. In all of the embodiments of the present invention, it is important to distinguish the difference between a central strength member 51, like the typical FRP rod, and a filler rod, like the filler rod 28 of FIGS. 1A and 1B. In the prior art of FIGS. 1A and 1B, the diameter of the central strength member 23 is about the same as the diameter of the filler rod 28. The diameter and the cross-sectional shape are not ways to distinguish the central strength member 23 from the filler rod 28.

The material used, and in particular the strength of the material used, is the best way to distinguish a central strength member from a filler rod. A filler rod is used as a place holder. Therefore, it is cheaply formed and may be a constructed of a solid dielectric material. The tensile strength of a filler rod is much lower than a central strength member, such as one or more orders lower for a same diameter. For example, in the cable designs of the present invention, the buffer tubes are about 2.5 mm in diameter. Therefore, the diameter of any filler rod in the present invention would match the diameter of the buffer tubes and be about 2.5 mm in diameter. A filler rod with a 2.5 mm diameter has a tensile strength of about 50 newtons (11.4 pounds).

Typical central strength members 23/51 are formed of a dielectric material with embedded reinforcement materials, e.g., short lengths of fiber, throughout the length of the strength member. The generic acronym FRP stands for “fiber reinforced polymer,” and can include a glass reinforced polymer (GRP), such as a fiber glass reinforced polymer. However, other types and lengths of fibers or reinforcement materials may be embedded within the dielectric material, e.g., polymer. For example, the embedded fibers or reinforcement materials may be formed of aramid fibers (sold under the trademark Kevlar®), bamboo fibers or shavings, nano tubes, animal hair, metal/alloy strands, etc. The embedded reinforcement materials add cost, weight and/or rigidity, all of which are undesirable in a filler rod 28. Also, it may also be possible for the central strength member 23/51 to include or be formed of metal, such as stranded steel wires or a solid steel wire, as further discussed herein.

FRP central strength members and steel wire central strength members show much higher tensile strengths as compared to filler rods 28. For example, a 1 mm diameter GRP rod has a tensile strength of about 368 newtons (82 pounds), meaning the GRP rod does not break and has less than a 1% elongation when 368 newtons (82 pounds) of tensile force is applied thereto. A GRP rod with a 2.3 mm diameter has a 2,692 newton (600 pound) tensile strength. One manner to distinguish a filler rod 28 from a central strength member in the context of this application is therefore by a tensile strength. The tensile strength of the filler rod 28 is well less than 50 pounds, such as less than 40 pounds or less than 30 pounds. Likewise, the tensile strength of the central strength member with embedded reinforcement materials is greater than 50 pounds. All of the central strength members in the Figures of the present invention will have a tensile strength greater than 70 pounds.

As shown in FIG. 3, at least one element holds the first and second buffer tubes 53 and 59 in the SZ stranding path along the central strength member 51 during the manufacturing process. Typically, first and second binders 43 and 45 would be helically wrapped around the cable core 41. The first binder 43 would be wrapped clockwise, like the first binder 35 in FIG. 1B. The second binder 45 would be wrapped counterclockwise, like the second binder 37 in FIG. 1B. The first and second binders 43 and 47 would overlap periodically along the length of the cable core 41, and may be formed of a strong polymer, nylon, polyester, KEVLAR, etc.

The embodiments of the present invention may also include one or more ripcords, such as first and second ripcords 65 and 67. The ripcords 65 and 67 are not part of the SZ stranded cable core 41. Therefore, the ripcords 115 are not SZ stranded and also do not spiral in a helical pattern like the first and second binders 43 and 45. Rather, the first and second ripcords 65 and 67 stay in a same placement relative to an overlap 69 in the armor layer 47. It is preferred that no ripcord 65 or 67 be placed at the overlap 69 of the armor layer 47 because it is very difficult to tear through two layers of the armor layer 47 with a ripcord 65 or 67 and/or the ripcord 65 or 67 may break when attempting to pull it through the overlap 69 of the armor layer 47. To keep the ripcords 65 and 67 properly positioned relative to the armor layer 47, the ripcords 65 and 67 may be adhered to an inner surface of the armor layer 47.

The first and second ripcords 65 and 67 are positioned about 180 degrees apart, so that the cable core 41 can be easily separated from the ripped open armor layer 47. In one embodiment, the first and second ripcords 65 and 67 are formed of stranded aramid fibers. For example, each of the first and second ripcords 65 and 67 may be formed of plural stranded aramid fibers, each aramid fiber having a diameter of about 1/1000 of an inch, such that an overall diameter of the stranded bundle of aramid fibers is about 20 to 40 thousandths of an inch, more preferably about 25 to 35 thousandth of an inch, such as about 30 to 32 thousandth of an inch. Larger or smaller diameter ripcords 65 or 67 may be possible and may be dependent upon the material being used to form the ripcords 65 and 67. For example, the ripcords 65 and 67 may have a larger diameter when being formed of polyester.

As previously mentioned, the cable core 41 may be surrounded by the armor layer 47. The armor layer 47 is typically corrugated to improve its strength, bending, and crush resistance, or may be a non-corrugated, smooth tape if added crush resistance is not needed. The width of the armor layer 47 from a first side edge 71 to an opposite, second side edge 73 is about 12 mm to 30 mm, more preferably about 15 to 28 mm, such as less than 27 mm, or about 25 mm or less.

As shown in the cross-sectional drawings, the second side edge 73 of the armor layer 47 is overlapped with the first side edge 71 of the armor layer 47. Typically, the armor layer 47 is formed of a metal or alloy, such as steel, copper or aluminum, and is corrugated. A thickness of the armor layer 47 from the peaks to the valleys of the corrugations is about 0.007 to 0.012 inches. In a preferred embodiment, the overlap 69 has a dimension of about 0.07 to 0.08 inches. Alternatively, the armor layer 47 may be formed without an overlap 69 by an extruded polymer, such as polyvinylchloride (PVC), if a totally dielectric cable is desired. A dielectric, armor layer 47 could also be formed of other polymers with a rigidity, or tear/puncture resistance, greater than the material used to form the outer jacket 49.

The outer jacket 49 is formed of a polymer and extruded onto the armor layer 47 with a substantially uniform thickness of about 0.045 to 0.055 inches, e.g., about 0.05 inches. An outer surface 75 of the outer jacket 49 will show an approximately triangular profile in cross-section, due to the air gap 63. In a preferred embodiment, the air gap 63 is large enough to allow the central strength member 51 to abut the first and second binders 43 and 45 and portions of the armor layer 47 exposed between the first and second binders 43 and 45. The triangular profile will rotate clockwise as shown by the cross-section sequence depicted in FIGS. 3-6 along the length of the optical cable 40 until the cable core 41 encounters the switchback 61. Then, the triangular profile of the outer surface 75 of the outer jacket 49 will rotate counterclockwise until the next switchback 61 is encountered in the cable core 41. In other words, the outer surface 75 of the outer jacket 49 is not circular as in the prior art cross-section of FIG. 1A. However, the switchbacks 61 will be readily apparent by inspecting the outer surface 75 of the outer jacket 49. This may be beneficial to a technician when determining the proper location to perform a mid-span access.

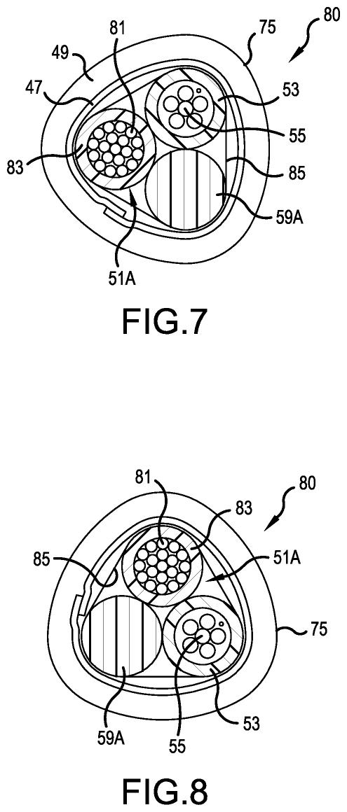

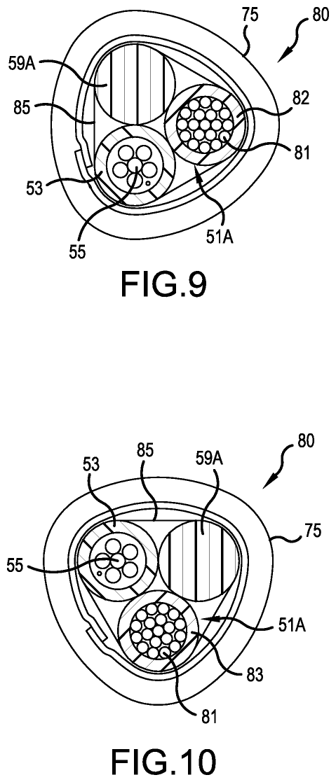

FIG. 7 is a cross-sectional view taken along line A-A in FIG. 2 of an optical cable 80 in accordance with a second embodiment of the present invention. The optical cable 80 of FIGS. 7-10 is identical to the optical cable 40 of FIGS. 3-6, except for three modifications. First, the second optical cable 80 illustrates that the central strength member 51 does not need to be a dielectric member, e.g., a GRP rod. In FIGS. 7-10, the central strength member 51A is formed as plurality of stranded steel wires 81 covered or surrounded by a polymer upjacket 83. Although not shown in FIGS. 7-10, using stranded steel wires 81 may allow the central strength member 51A to be formed with a smaller diameter.

A second modification found in the optical cable 80 is that the second buffer tube 59 has been replaced by a filler rod 59A. The filler rod 59A is formed of a dielectric material which does not include any embedded reinforcement material therein. The filler rod 59A has a same diameter as the first buffer tube 53 and is SZ stranded along with the first buffer tube 53 around the central strength member 51A along a length of the optical cable 80. The filler rod 59A is held by the at least one element, such as the first and second binders 43 and 45 of FIGS. 3-6. The air gap 63 would now exist between the first buffer tube 53 and the filler rod 59A, as the first buffer tube 53 and the filler rod 59A follow the SZ stranding path along the central strength member 51A. The filler rod 59A would be a cost saving modification if any cable embodiment of the present invention needed a reduced optical fiber count, such as an optical cable with twenty-four or fewer optical fibers 55.

A third modification found in the optical cable 80 is that the first and second binders 43 and 45 of FIGS. 3-6 may be replaced with a continuous sub-jacket 85, such as a heat shrink layer, adhesive tape, or secondary extrusion of a polymer. The sub-jacket 85 would serve the purpose of holding the first buffer tube 53 and the filler rod 59A in the SZ stranding path along the central strength member 51A during the manufacturing process. Of course, a sub-jacket 85 could be used instead of the first and second binders 43 and 45 in the optical cable 40 of FIGS. 3-6 and in the other embodiments of the present invention.

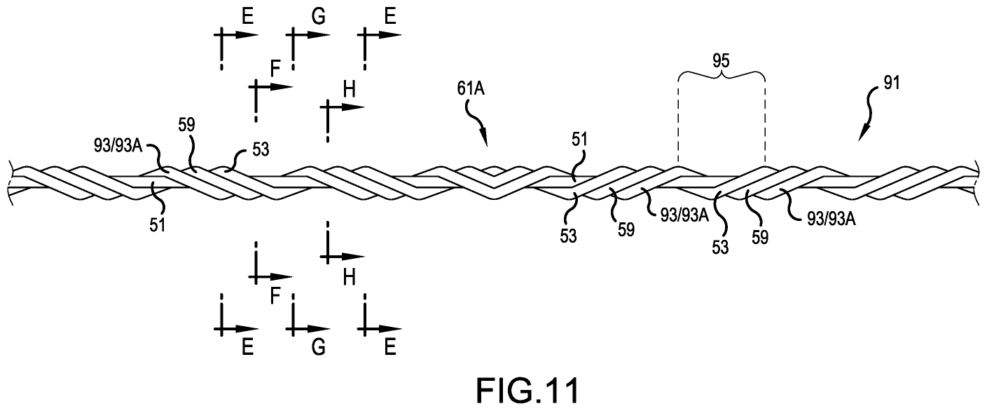

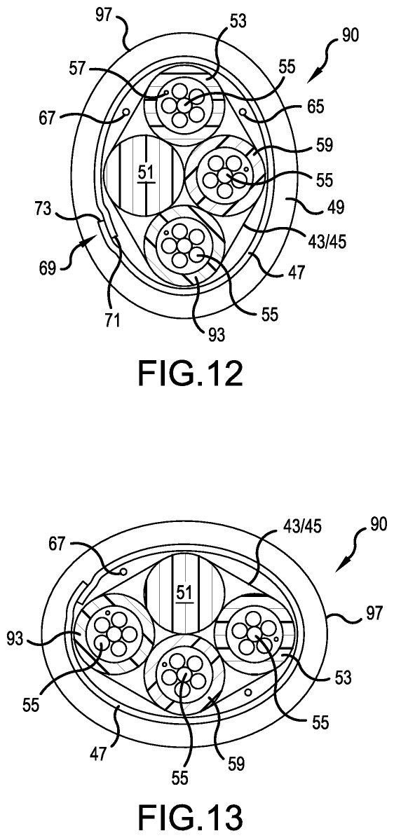

FIG. 11 is a side view of a four-member cable core 91 in accordance with the present invention, with the binders 43/45, armor layer 47 and outer jacket 49 removed. FIG. 12 is a cross-sectional view taken along line E-E in FIG. 11 of an optical cable 90 in accordance with a third embodiment of the present invention. In FIG. 12, the binders 43 and 45, the armor layer 47, and the outer jacket 49 are included in the drawing.

In FIGS. 11 and 12, the cable core 91 of the optical cable 90 includes the central strength member 51. The first buffer tube 53 is stranded around the central strength member 51 along a length of the cable core 91. The first buffer tube 53 has an outer diameter of about 2.5 mm, e.g., about 0.1 inches, although other sized buffer tubes may be used, such as a 2.0 mm buffer tube. The first buffer tube 53 surrounds six optical fibers 55 and one or more ripcords 57. However, other numbers of optical fibers 55 and ripcords 57 may be surrounded by the first buffer tube 53, such as at least eight or at least twelve optical fibers 55. For example, in a preferred embodiment, when the first buffer tube 53 is sized at 2.5 mm and the optical fibers have a 200 micron diameter, the first buffer tube 53 may surround twenty-four optical fibers 55 and one or more ripcords 57. The second buffer tube 59 and a third buffer tube 93 are also stranded around the central strength member 51 along the length of the cable core 91. The second and third buffer tubes 59 and 93 may be formed the same as the first buffer tube 53, and surround a plurality of optical fibers 55, such as six optical fibers 55 as shown, or up to twenty-four optical fibers 55, as discussed above.

The first, second and third buffer tubes 53, 59 and 93 are stranded about the central strength member 51 in a S-Z stranding pattern. As best seen in FIG. 11, in the S-Z stranding pattern the first, second and third buffer tubes 53, 59 and 93 twist about the central strength member 51 for several revolutions in a clockwise direction, e.g., five to seven revolutions, then reverse direction at first switchback 61A and twist about the central strength member 51 for several revolutions in a counterclockwise direction, e.g., five to seven revolutions, to another switchback 61A. A pattern of clockwise rotations and counterclockwise rotations repeats along the length of the cable core 91 of the optical cable 90, in a manner similar to the zones A and B between first, second, third, fourth, etc. switchbacks 27, 29, 31, 33, shown in FIG. 1B.

In FIG. 11, an air gap 95 exists between the first buffer tube 53 and the third buffer tube 93, as the first, second and third buffer tubes 53, 59 and 93 follow a SZ stranding path along the central strength member 51. In FIG. 11, the SZ stranding pattern is the same as a five-around-one pattern, with the first, second and third buffer tubes 53, 59 and 93 occupying the positions of the first, second and third cable elements being SZ stranded around the central strength member 51. No cable elements exist in the fourth and fifth positions of the five-around-one configuration. Rather, the fourth and fifth positions constitute the air gap 95. In other words, if a diameter of the first buffer tube 53 is equal to a diameter of the second buffer tube 59 and the third buffer tube 93, and if two filler rods, having a same diameter as the first, second and third buffer tubes 53, 59 and 93 were stranded along with the first, second and third buffer tubes 53, 59 and 93, the stranding would be a five-around-one configuration with no air gaps. A cross-section of such an arrangement would show a continuum of abutments between the first, second and third buffer tubes 53, 59 and 93 and the two filler rods, similar to the abutments shown in the six-around-one configuration of FIG. 1A.

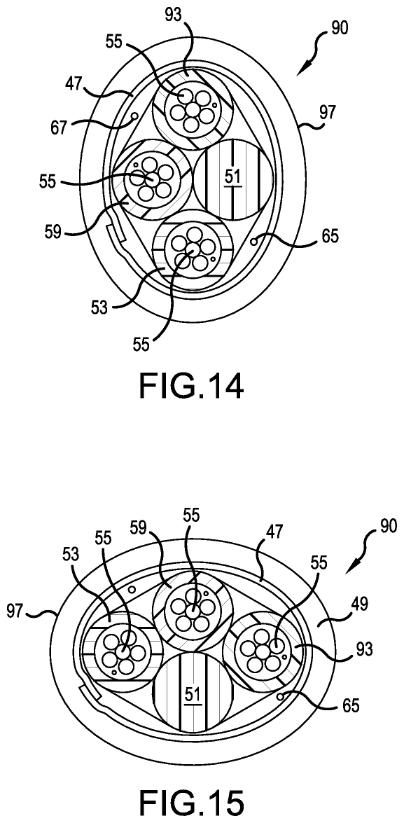

The third buffer tube 93 may be made in the same dimensions, and of the same materials, as the first and second buffer tubes 53 and 59. Besides the third buffer tube 93, the remaining elements of the optical cable 90 may be may in the same dimensions and of the same materials as discussed in relation to FIGS. 2-10. An outer surface 97 of the outer jacket 49 will show an approximately oval profile in cross-section, due to the air gap 95. In a preferred embodiment, the air gap 95 is large enough to allow the central strength member 51 to abut the first and second binders 43 and 45 and portions of the armor layer 47 exposed between the first and second binders 43 and 45. The oval profile will rotate clockwise as shown by the cross-section sequence depicted in FIGS. 12-15 along the length of the optical cable 90 until the cable core 91 encounters the switchback 61A. Then, the oval profile of the outer surface 97 of the outer jacket 49 will rotate counterclockwise until the next switchback 61A is encountered in the cable core 91. In other words, the outer surface 97 of the outer jacket 49 is not circular as in the prior art cross-section of FIG. 1A. However, the switchbacks 61A will be readily apparent to the technician and may be beneficial when determining the proper location to perform a mid-span access.

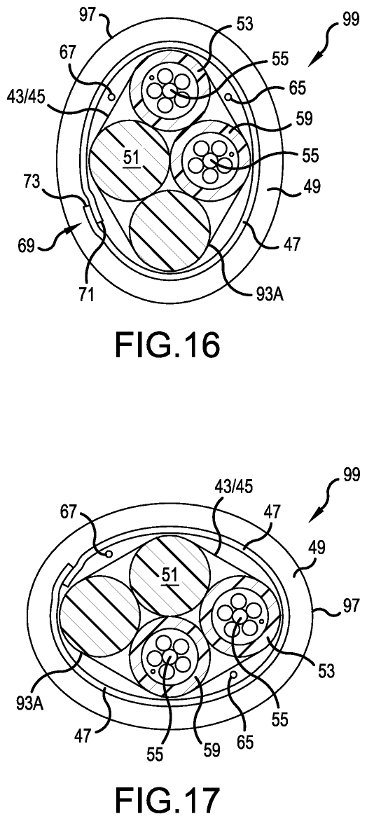

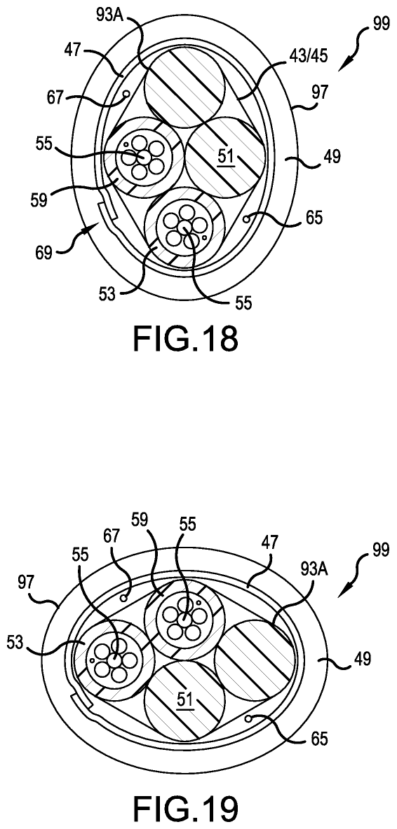

FIG. 16 is a cross-sectional view taken along line E-E in FIG. 11 of an optical cable 99 in accordance with a fourth embodiment of the present invention. The optical cable 99 of FIGS. 16-19 is identical to the optical cable 90 of FIGS. 12-15, except that the third buffer tube 93 has been replaced by a filler rod 93A. The filler rod 93A is formed of a dielectric material which does not include any embedded reinforcement material therein. The filler rod 93A has a same diameter as the first and second buffer tubes 53 and 59 and is SZ stranded along with the first and second buffer tubes 53 and 59 around the central strength member 51 along a length of the cable core 91. The filler rod 93A is held by the at least one element, such as the first and second binders 43 and 45 of FIGS. 12-15. The air gap 95 would now exist between the first buffer tube 53 and the filler rod 93A, as the first buffer tube 53, the second buffer tube 59 and the filler rod 93A follow the SZ stranding path along the central strength member 51. The filler rod 93A would be a cost saving modification if any cable embodiment of the present invention needed a reduced optical fiber count, such as an optical cable with forty-eight or fewer optical fibers 55.

With the cables 40, 80, 90 and 99 of the present invention, the pull force needed to pull the cable through a conduit is greatly reduced due to the smaller size and weight of the cable. Also, if the cables of the present invention are installed in an outside environment, the wind and ice loads on the cable and its supporting structures are greatly reduced due to the smaller sizes of the cables. The cables of the present invention exhibit better bend performance, which allows for tighter bends in the cables during installation. Currently, installers use a twelve-inch diameter guide wheel at a bend and do not bend the cable more than ninety degrees. It is believed that the cables of the present invention can be installed with a three-inch wheel and may be bent more than one hundred twenty degrees. The cables of the present invention exhibit better crush resistance. The smaller size of the outer jacket 49 translates into a tighter curve radius for the inner corrugated armor layer 47. The tighter the curve radius of the armor layer 47, the more strength that the armor layer 47 exhibits to support a crushing force.

Water blocking materials may be added to the various embodiments of the invention. Water blocking threads, yarns or tapes, such as those sold under the trademark SWELLCOAT™, manufactured by FIBER-LINE®, may optionally be included to block water flow into the cable core and/or buffer tubes. Such threads, yards or tapes are capable of absorbing a water weight up to 100× the weight of the dry thread, yarn or tape. For example, threads, yarns or tapes with water swellable powder may be wrapped around or placed alongside the cable core to prevent water migration. Alternatively, the threads or yarns may be added elements to be stranded along with the cable core. A tape or core wrap with water swellable powder may be applied over the stranded core. In a preferred embodiment, water swellable powder is applied directly to the central strength member, the buffer tube(s), any filler rod, and/or the inside of the armor layer, such that the use of additional threads, yarns and tapes may be avoided. Alternatively, a water-blocking or water-absorbing gel may be added to the cable core.

In the various embodiments of the present invention, the buffer tubes are of a loose tube design for accommodating eight, twelve or twenty-four optical fibers, which are disconnected, i.e., loose. Alternatively, the optical fibers may be ribbonized, e.g., connected to each other by a rolled or collapsible ribbon. More or fewer optical fibers may be included in each buffer tube as well, such as two bundles of twelve fibers each in each buffer tube.

In the various embodiments of the present invention, the optical fibers may all be of a single mode type, may all be of a multimode type, or may be a mixture of the two types. The optical fibers may all be a same diameter or may be of different diameters such as 200 um, 250 um, or other diameters.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. An optical cable comprising:
a central strength member;
a first buffer tube surrounding at least one optical fiber;
a second buffer tube surrounding at least one optical fiber, wherein said first and second buffer tubes are SZ stranded around said central strength member along a length of said optical cable, and wherein an air gap exists between said first buffer tube and said second buffer tube as said first and second buffer tubes follow a SZ stranding path along said central strength member;
at least one element holding said first and second buffer tubes in the SZ stranding path along said central strength member; and
an outer jacket surrounding said at least one element, said first and second buffer tubes and said central strength member.

2. The optical cable according to claim 1, wherein said at least one element includes first and second binders.

3. The optical cable according to claim 1, wherein said central strength member is formed as a dielectric strength member having embedded reinforcement material therein.

4. The optical cable according to claim 1, further comprising:
an armor layer surrounding said at least one element, said first and second buffer tubes and said central strength member, wherein said armor layer is surrounded by said outer jacket.

5. The optical cable according to claim 4, wherein said armor layer is formed by a corrugated metal sheet.

6. The optical cable according to claim 1, further comprising:
a filler rod formed of a dielectric material which does not include any embedded reinforcement material therein, wherein said filler rod is S-Z stranded together with said first and second buffer tubes around said central strength member along the length of said optical cable, and wherein said air gap is made smaller by said filler rod, but still exists as said first and second buffer tubes and filler rod follow the SZ stranding path along said central strength member.

7. The optical cable according to claim 6, wherein said filler rod has a tensile strength of less than 50 pounds such that less than 50 pounds of force will cause said filler rod to break or elongate by more than 1%; and
wherein said central strength member has a tensile strength greater than 50 pounds, such that less than 50 pounds of tensile force will not cause said central strength member to break or elongate by more than 1%.

8. The optical cable according to claim 1, wherein said first buffer tube has a first diameter and occupies a first angular portion of the three hundred sixty degrees surrounding said central strength member, and said air gap occupies a second angular portion of the three hundred sixty degrees surrounding said central strength member, which is greater than the first angular portion.

9. The optical cable according to claim 1, wherein said at least one optical fiber surrounded by said first buffer tube includes at least eight optical fibers, and wherein said at least one optical fiber surrounded by said second buffer tube includes at least eight optical fibers.

10. An optical cable comprising:
a central strength member;
a first buffer tube surrounding at least one optical fiber, wherein said first buffer tube is SZ stranded around said central strength member along a length of said optical cable, and wherein an air gap exists between adjacent lays of said first buffer tube as said first buffer tube follows a SZ stranding path along said central strength member, wherein said first buffer tube has a first diameter and occupies a first angular portion of the three hundred sixty degrees surrounding said central strength member, and said air gap occupies a second angular portion of the three hundred sixty degrees surrounding said central strength member, which is greater than the first angular portion;
at least one element holding said first buffer tube in the SZ stranding path along said central strength member; and
an outer jacket surrounding said at least one element, said first buffer tube and said central strength member.

11. The optical cable according to claim 10, further comprising:
a filler rod formed of a dielectric material, wherein said filler rod is SZ stranded along with said first buffer tube around said central strength member along the length of said optical cable and held by said at least one element, and wherein said air gap exists between said first buffer tube and said filler rod as said first buffer tube and said filler rod follow the SZ stranding path along said central strength member.

12. The optical cable according to claim 10, further comprising:
an armor layer surrounding said at least one element, said first buffer tube and said central strength member, wherein said armor layer is surrounded by said outer jacket.

13. The optical cable according to claim 12, wherein said armor layer is formed of a polymer.

14. The optical cable according to claim 10, wherein the second angular portion is at least twice as large as the first angular portion.

15. An optical cable consisting essentially of:
a central strength member;
a first buffer tube surrounding at least one optical fiber;
a second buffer tube surrounding at least one optical fiber, wherein said first and second buffer tubes are SZ stranded around said central strength member along a length of said optical cable to form a cable core, and wherein an air gap exists between said first buffer tube and said second buffer tube as said first and second buffer tubes follow a SZ stranding path along said central strength member;
first and second binders holding said first and second buffer tubes in the SZ stranding path along said central strength member;
an armor layer surrounding said cable core and first and second binders; and
an outer jacket surrounding said armor layer.

16. The optical cable according to claim 15, wherein said first buffer tube includes at least twelve optical fibers and said second buffer tube includes at least twelve optical fibers.

17. The optical cable according to claim 15, wherein said armor layer is formed of a metal or alloy.

18. The optical cable according to claim 15, wherein said central strength member is formed of a fiber reinforced polymer (FRP).

19. The optical cable according to claim 15, wherein said central strength member abuts said first and second binders.

20. The optical cable according to claim 19, wherein said central strength member also abuts said armor layer.
